(19) United States
(12) Patent Application Publication
(10) Pub. No.: US 2016/0125559 A1
(43) Pub. Date: May 5, 2016

(54) TRIP PLANNING PLATFORM

(71) Applicant: Trippd Inc., San Francisco, CA (US)

(72) Inventor: Sina Shekou, San Francisco, CA (US)

(21) Appl. No.: 14/930,272

(22) Filed: Nov. 2, 2015

Related U.S. Application Data
(60) Provisional application No. 62/074,068, filed on Nov. 2, 2014.
(60) Provisional application No. 62/196,801, filed on Jul. 24, 2015.

(51) Int. Cl. G06Q 50/14; G06Q 10/02; G06Q 50/00; G01C 21/34

(52) U.S. Cl. CPC G06Q 50/14; G01C 21/343; G06Q 10/025; G06Q 50/01

(57) ABSTRACT

Systems and methods for a trip planning platform are provided. In example embodiments, an indication of a content item associated with a trip is received from a particular user of a social collaboration service. A content card representing the content item is generated. A trip itinerary including the content card is assembled for an organizer user of the social collaboration service. The trip itinerary is presented on a user interface of a user device of a candidate trip participant. Communication pertaining to the trip itinerary is facilitated between the organizing user and the candidate trip participant.

### RELATED APPLICATIONS

This application claims the priority benefit, under 35 U.S.C. Section 119(e), to U.S. Provisional Application No. 62/074,068, entitled “TRIP PLANNING PLATFORM,” filed Nov. 2, 2014, which is hereby incorporated by reference in its entirety. This application also claims the priority benefit, under 35 U.S.C. Section 119(e), to U.S. Provisional Application No. 62/196,801, entitled “TRIP PLANNING PLATFORM,” filed Jul. 24, 2015, which is hereby incorporated by reference in its entirety.

### TECHNICAL FIELD

Embodiments of the present disclosure relate generally to social networking and web technology and, more particularly, but not by way of limitation, to a trip planning platform.

### BACKGROUND

The most memorable experiences are often those spent with others. Planning such experiences can be a challenge when a wide variety of options are available and multiple people are included with the decision making process. In addition, getting a group of people to commit to a plat can be frustrating, time consuming, and difficult as the process can involve assimilating content from fragmented sources, coordinating logistics for a group of people, and more.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some example embodiments.

FIG. 2 is a block diagram illustrating an example embodiment of a trip planning system, according to some example embodiments.

FIG. 3 is a diagram showing high-level interactions between various entities when using a trip planning system for collaborative trip planning, according to some example embodiments.

FIG. 4 is a flow diagram illustrating an example method for collaborative trip planning, according to some example embodiments.

FIG. 5 is a flow diagram illustrating an example method for collaborative trip planning using a widget, according to some example embodiments.

FIG. 6 is a diagram showing various example components of an example content card, according to some example embodiments.

FIG. 7 is a flow diagram illustrating an example method for automatically generating content cards, according to some example embodiments.

FIG. 8 is a flow diagram illustrating an example method for detecting a trip designator in a communication and altering a trip itinerary, according to some example embodiments.

FIG. 9 is a flow diagram illustrating an example method for altering a trip itinerary based on votes from candidate trip participants, according to some example embodiments.

FIG. 10 is a flow diagram illustrating an example method for memorializing a trip using media content provided by trip participants, according to some example embodiments.

FIGS. 11-14 are user interface diagrams depicting various example user interfaces, according to some example embodiments.

FIG. 15 is a block diagram illustrating an example of a software architecture that may be installed on a machine, according to some example embodiments.

FIG. 16 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

According to various example embodiments described herein, a trip planning system 200 is configured to aid users in engineering, executing, memorializing, and sharing their experiences. For many users, the most memorable experiences are those they share with family and friends, but such experiences can often be difficult to plan. Accordingly, the trip planning system 200 described herein helps make the trip-planning process more seamless and efficient. For example, the trip planning system 200 supports the primary/lead person (also referred to herein as an “instigator”) that is generating a trip plan to pitch their idea to a group of people, achieve group commitment and get reimbursed shared expenses. Moreover, the trip planning system 200 enables the instigator to share the details and the memories of the experience amongst the people that attended (e.g., in the format of photos and videos, places they visited, their reviews of the locations they went to, etc.), by packaging such content into an itinerary that is designed to be visually appealing, and shareable with anyone. In addition, the trip planning system 200 enables the instigator to convert any itinerary into a guide that can be shared privately or publicly with anyone so they can copy it and engineer their own experiences.

In some embodiments, the trip planning process, performed in conjunction with the trip planning system 200, begins with a pre-planning stage that aids and enables the instigator to discover trip ideas, assemble these ideas into a plan, and pitch it to a group to collaborate on the decision making process (e.g., by providing comments, feedback, alternative suggestions, or voting) and get the members of the group committed to an itinerary (e.g., RSVP, reimbursement of shared expenses, or provide another indication of commitment to the trip). In some embodiments, the trip planning system 200 enables group members to download an application associated with the system 200 in order to have access to the itinerary during the trip, to have group collaboration features allowing the users to share photos and videos, to chat about the trip, and to package that experience into a visually appealing format, so that the group may reflect on the experience and share it with others.

Various embodiments describe a process of being able to clip content from anywhere (e.g., the web, email, integrated/connected services such as EVENTBRITE®, AIRBNB®, HOMEAWAY®, EXPEDIA®, TRIPADVISOR®, FACEBOOK®, TWITTER®, INSTAGRAM®, LINKEDIN®, or other websites for accommodations, flights, activities, tours, food, drinks, or events), and to convert that content into representations called Cards (herein, also referred to as content cards), which are data entities that represent physical entities such as places, locations, people, venues, objects, and so on. Put another way, the content cards can represent anything that users may want to experience. For example, if a group of users desire to go to Lake Tahoe, an instigator may find multiple accommodations online and put them into a Plan as Cards, so that the other users can discuss them, RSVP and book the desired one. Thus, after such cards are inserted into a plan, they are available to group members online or offline. Moreover, the content cards can be personalized by group members (e.g., modifying the content cards by group members can adding photos, reviews, ratings, or other user-specified content). Further, the content card can be booked (e.g., via 3rd party websites/services and integrated payment processing) and scheduled by being inserted into an itinerary in a particular day or time slot. Thus, rather than users being able to only “pin” or attach static images as trip ideas, the Cards represent actionable, clickable, and collaborative content that can be inserted into an itinerary, so that group members can actually perform or experience the underlying subject matter described in the cards.

In some embodiments, collaborative itinerary building may be provided. For example, the trip planning system 200 enables a user such as an instigator to create an itinerary that is a result of collaboration amongst a group of people that the instigator desires to travel with. Accordingly, various embodiments herein embody a unique collaborative process for enabling users to vote on things they want to experience, build a corresponding itinerary, and then go out and experience those things.

In some embodiments, after the experience is completed, the trip planning system 200 enables users to blend content (e.g., photos, videos, views, or chat messages) from among the users that were on the trip, into a visual representation of what that trip was. Thus, users that were not on the trip may view the content and, if they desire a similar experience, they may obtain a copy of the Plan in the form of a Guide or template, which they can then customize to generate their own experience.

Thus, according to various example embodiments described herein, the trip planning system 200 enables an instigator, planner, administrator, or organizer to engineer an experience by providing the instigator with a tool to obtain buy-in from other users, source feedback and collaboration, let users review and vote on aspects of the experience, structure an itinerary, and then go out and obtain the experience. Moreover, the trip planning system 200 enables the users to recreate the experience by blending the people who went, the places they went to, and collected assets from the trip (e.g., photos, videos, reviews of the places visited etc.,) for assembly into a visual story that is easy to digest (e.g., in the format of a webpage or flipbook). In this way, the attendees can memorialize and reflect on what they did, and others that did not attend can review the itinerary, obtain inspiration, and create a copy of the Plan in the form of a Guide, so they can start their own experience.

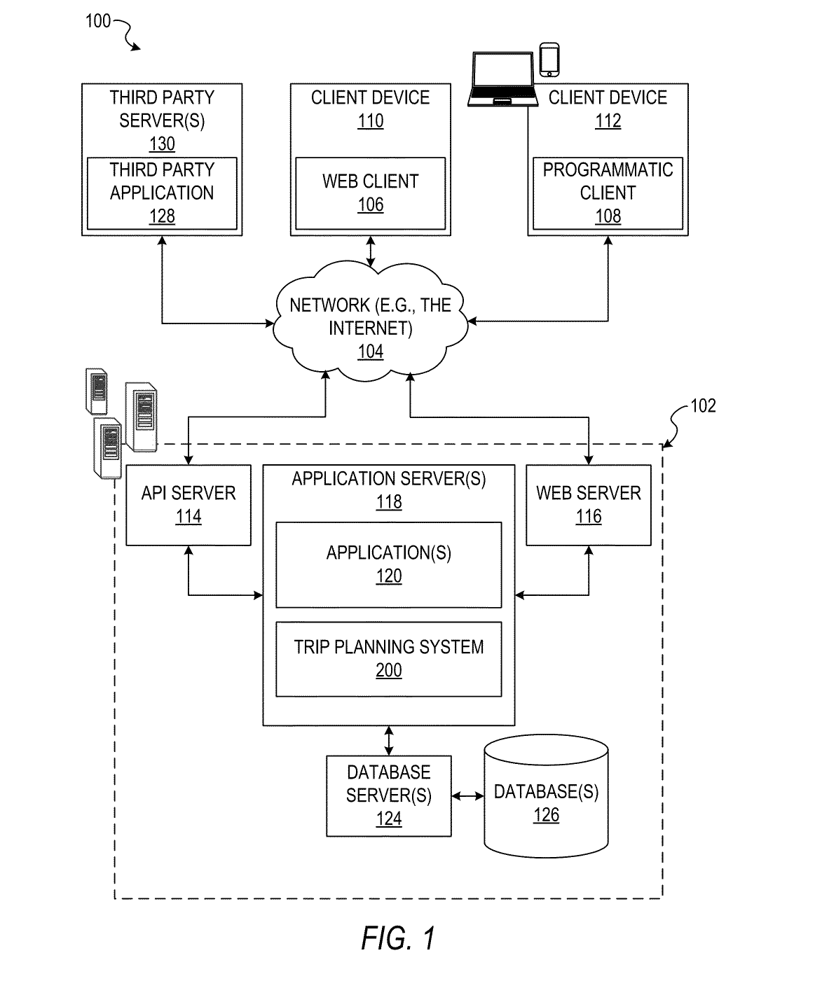

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser), and a programmatic client 108 executing on respective client machines 110 and 112.

In various implementations, the client devices 110 and 112 comprises a computing device that includes at least a display and communication capabilities that provide access to the networked system 102 via the network 104. The client devices 110 and 112 comprise, but are not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic, game consoles, set-top box, network Personal Computer (PC), mini-computer, and so forth. In an example embodiment, the client devices 110 and 112 comprise one or more of a touch screen, accelerometer, gyroscope, biometric sensor, camera, microphone, Global Positioning System (GPS) device, and the like.

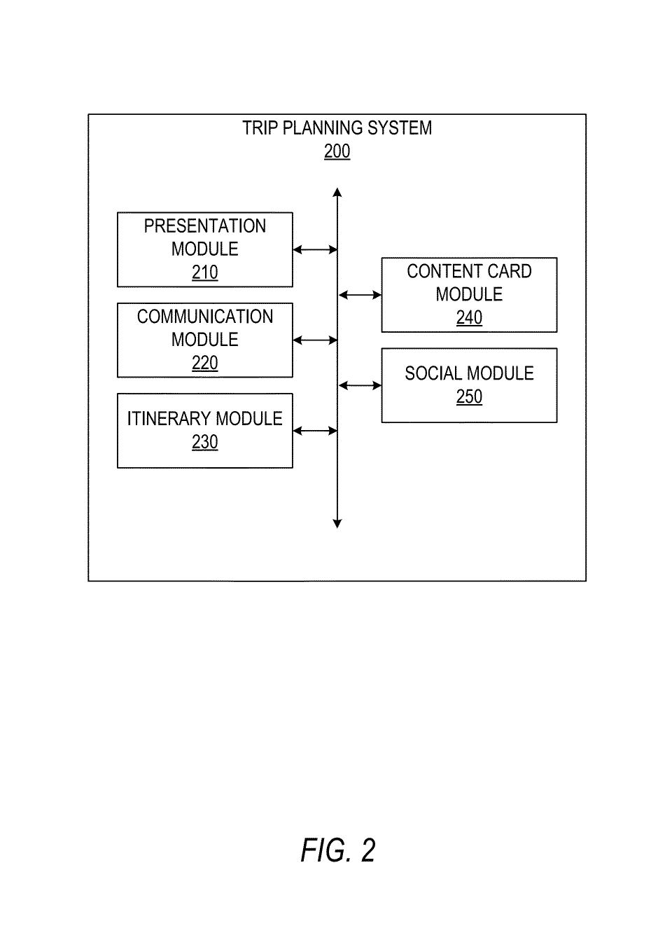

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various example embodiments, the applications 120 may be implemented on or executed by one or more of the modules of the trip planning system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102. With some embodiments, the application servers 118 hosts what is referred to herein as a trip planning system 200. The trip planning system 200 is described in more detail below in conjunction with FIG. 2.

Further, while the system 100 shown in FIG. 1 employs a client-server architecture, the present invention is of course not limited to such an architecture, and could equally well find application in a distributed, or peer-to-peer, architecture system, for example. The various applications 120 could also be implemented as standalone software programs, which do not necessarily have networking capabilities. In an example embodiment, the application servers 118 host a social collaboration service that facilities social networking, media share, and communication between members of the social collaboration service. In some embodiments, the trip planning system 200 is a part of the social collaboration service while in other embodiments, the trip planning system 200 is separate from the social collaboration service but is communicatively coupled to the social collaboration service.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

FIG. 2 is a block diagram of the trip planning system 200 that provides functionality to facilitate collaboration of trip planning and memorialize a trip with media capture by trip participants, according to some example embodiments. In an example embodiment, the trip planning system 200 includes a presentation module 210, a communication module 220, an itinerary module 230, a content card module 240, and a social module 250. All, or some, of the modules 210-250 of FIG. 2, communicate with each other, for example, via a network coupling, shared memory, and the like. It will be appreciated that each module can be implemented as a single module, combined into other modules, or further subdivided into multiple modules. Other modules not pertinent to example embodiments can also be included, but are not shown.

In some implementations, the presentation module 210 provides various presentation and user interface functionality operable to interactively present (or cause presentation) and receive information from the user. For instance, the presentation module 210 can cause presentation of user interfaces configured to facilitate collaborative trip planning (e.g., displaying an itinerary, a content card, or group messages pertaining to a particular itinerary item). In various implementations, the presentation module 210 presents or causes presentation of information (e.g., visually displaying information on a screen, acoustic output, haptic feedback). Interactively presenting information is intended to include the exchange of information between a particular device and the user. The user may provide input to interact with the user interface in many possible manners such as alphanumeric, point based (e.g., cursor), tactile, or other input (e.g., touch screen, tactile sensor, light sensor, infrared sensor, biometric sensor, microphone, gyroscope, accelerometer, or other sensors). It will be appreciated that the presentation module 210 provides many other user interfaces to facilitate functionality described herein. Further, it will be appreciated that “presenting” as used herein is intended to include communicating information or instructions to a particular device that is operable to perform presentation based on the communicated information or instructions.

The communication module 220 provides various communications functionality and web services. For example, the communication module 220 provides network communication such as communicating with the networked system 102, the client devices 110 and 112, and the third party server(s) 130. In various example embodiments, the network communication can operate over wired or wireless modalities. Web services are intended to include retrieving information from the third party server(s) 130, the database(s) 126, and the application server(s) 118. In some implementations, information retrieved by the communication module 220 comprises data associated with the user (e.g., user profile information from an online account, social network service data associated with the user), data associated with one or more items listed on an e-commerce website (e.g., images of the item, reviews of the item, item price), or other data to facilitate the functionality described herein. In further example embodiments, the communication module 220 provides functionality to generate alerts and notifications. For example, the notifications comprise a text message, such as Short Message Service (SMS) messages, Multimedia Messaging Service (MMS), Enhanced Messaging Service (EMS), and so forth.

The itinerary module 230 provides functionality to generate and maintain a trip itinerary. For example, the itinerary module 230 assembles an itinerary comprising content cards. In an embodiment, the itinerary is a temporally ordered sequence of items such as a particular group of content cards that represent activities, geolocations, or events associated with a particular trip.

The content card module 240 provides functionality to generate and maintain content cards. Content cards represent content items such as activities, geolocations, or events associated with a particular trip. In various embodiments, a content card is a portable, consumable packaging for content that would otherwise be difficult to access or include in a collection (e.g., an itinerary or plan) along with other content cards. Content cards can included content “clipped” or extracted from a wide variety of sources such as a website (e.g., websites associated with providing accommodations, flights, activities, tours, food, drinks, or events) or social networking profiles (e.g., a FACEBOOK® profile). For example, a content card may include a link (e.g., a Uniform Resource Locator) to a particular resource and access information using the link, or, in another example, the content card can include data extracted from the resource such as text, images, or other media. In some instances, the content card module 240 summarizes or condenses data from a particular resource and includes the summarized data in the content card (e.g., an abridged version of a website page). While a particular content card comprise include information clipped from a source, the content card module 240 allows a user to personalize the particular content card. For instance, the content card can be personalized with ratings, reviews, photos, and other media of the user. The content card module 240 stores such personalization data in associated with a profile of the user on a social collaboration service or a social networking service. The content card module 240 can also manage privacy settings configured by the user that restricts or grants access to the personalization data associated with a particular content card. For example, a particular privacy configuration allows the personalization data may be accessible publicly and another privacy configuration allows the personalization data to be accessible only to contact members (e.g., friends) of the user on a particular social networking service.

The social module 250 provides functionality to facilitate various social networking activities on a social networking service or a social collaboration service. For example, the social module 250 identifies contact members of a particular member of a social networking service that have formed a relationship with the particular member. In other examples, the social module 250 facilitates various social networking functions such as messaging, friending, tagging, following, liking, and so forth.

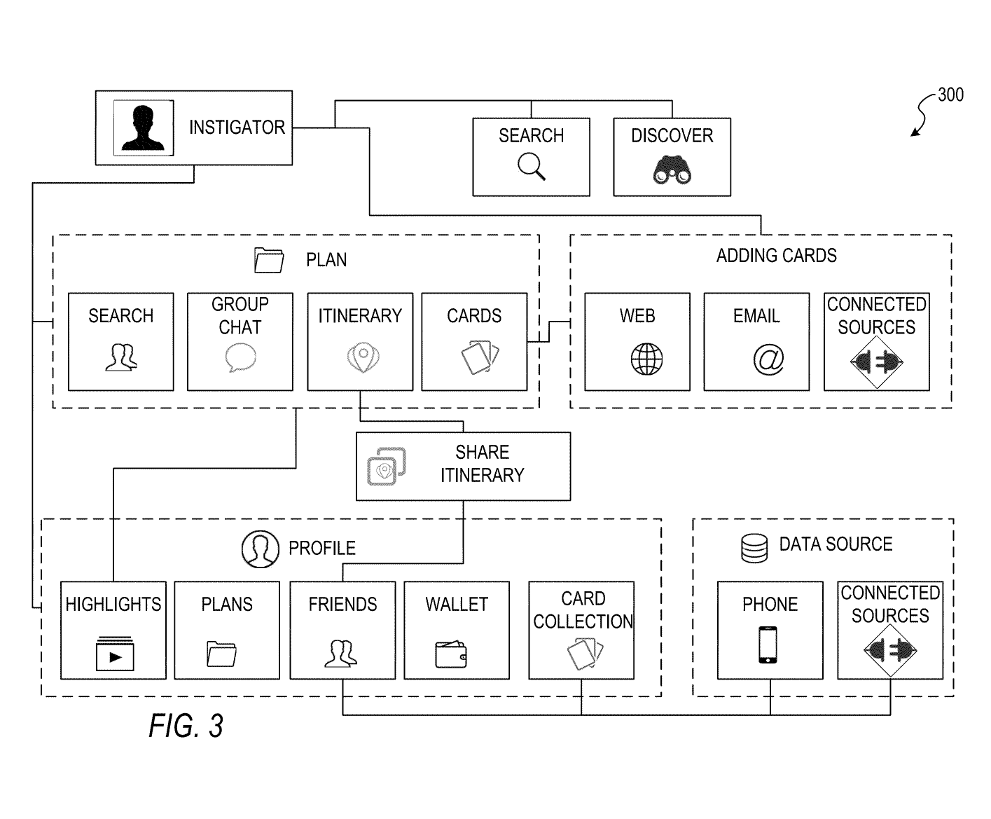

FIG. 3 is a diagram 300 showing high-level interactions between various entities when using the trip planning system 200 for collaborative trip planning. The trip planning system 200 provides a collaborative workspace for users to collaboratively plan a trip or event. In the diagram 300, an instigator or organizing user creates or searches previously created content cards to add to a plan or trip itinerary. The organizing user can also invite other users to assist in adding cards to the itinerary, provide comments regarding a particular content card, and so forth. In some embodiments, the content cards include dynamic data that is updated from data sources when the content card is accessed by a user. For example, a particular content card can include profile information from a social networking service profile that is dynamically retrieved each time the content card is displayed on a user interface.

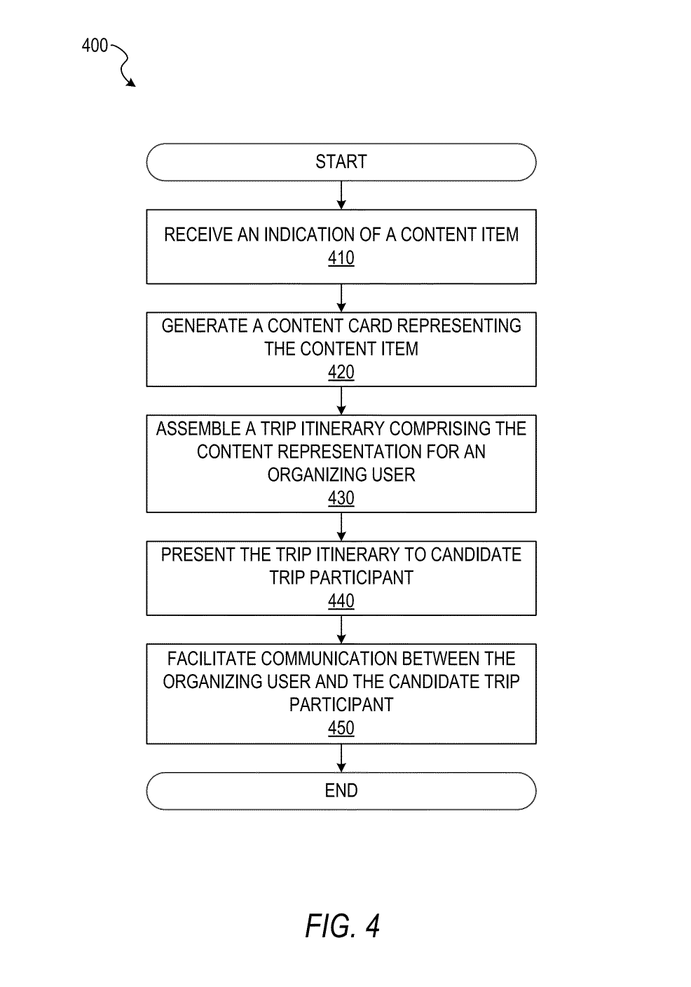

FIG. 4 is a flow diagram illustrating an example method 400 for collaborative trip planning. The operations of method 400 are performed by components of the trip planning system 200, and are so described below for the purposes of illustration.

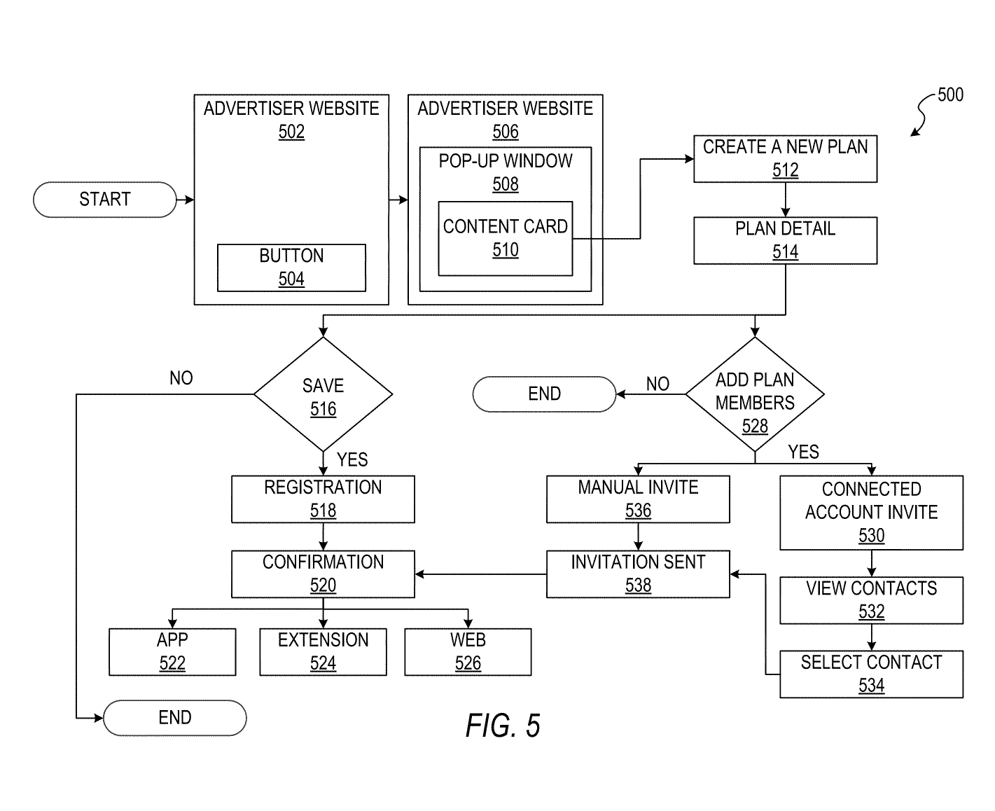

At operation 410, the communication module 220 receives an indication of a content item associated with a trip from a particular user of a social collaboration service. For example, the user submits data for the content item to the communication module 220 that is to be used by the content card module 240 to generate a content card. In a specific example, the user submits a title, an image, and a textual description to be used to generate a content card (e.g., a restaurant name, image, and description). In another example, the user submits an indication of the content item such a link to a website for the content item (e.g., a link to a restaurant website). In some example embodiments, the user provides an indication of a particular webpage on a website and the content card module 240 or the communication module 220 receives, scrapes, or extracts metadata from the particular webpage (e.g., a textual description, title of the page, an image, product pricing data, or another contextually specific piece of metadata). As discussed further in connection with FIG. 5 below, the user can provide the indication of the content item to the communication module 220 via a widget executing on a third-party website.

At operation 420, the content card module 240 generates a content card representing the content item. For example, the content card module 240 extracts data corresponding to the content item (e.g., a restaurant website) and generates the content card using the extracted data. For example, the organizing user, or another user of the trip planning system 200, is browsing a website that includes a “Plan This” button, which is a widget executing on the website. When the user activates the button, the communication module 220 receives an instruction to generate a content card based on the particular page the user is browsing. The content card module 240 extracts data from the particular page or uses data received at the communication module 220 with the instruction to generate the content card for the particular page. In a specific example, the particular page may be for a hotel and the content card module 240 generates a contend card that includes data pertaining to the hotel such as a name, image, geolocation, current availability, pricing, and other data associated with the hotel. In some embodiments, the content card module 240 summarizes or abridges the data extracted or received for the content item.

At operation 430, the itinerary module 230 assembles a trip itinerary including the content card for an organizing user of the social collaboration service. In various embodiments, the trip itinerary or trip plan comprises a plurality of temporally ordered entities such as content cards, locations, events, activities, and so forth pertaining to a trip. For example, the itinerary module 230 assigns the content card (e.g., a particular content card representing a location of interest to visit) to a particular date and time within the trip itinerary.

In some instance, the itinerary module 230 conforms to various logistics rules and conditions either predefined or specified by a user. For example, the itinerary module 230 may raise an error (e.g., a user interface notification to the user) if a particular time and geolocation in the trip itinerary is logistically inconsistent with another time and geolocation in the itinerary (e.g., temporally overlapping itinerary items or other logistical type problems). In other examples, the user specifies rules or conditions follow by the itinerary module 230 such as a user-specified amount of time to dedicate to a particular city or region on the trip or a particular budget amount to not exceed.

In further embodiments, the itinerary module 230 determines availability associated with a particular itinerary item (e.g., a particular content card) in response to a request by a candidate trip participant to register or RSVP for the particular itinerary item. For example, a particular itinerary item comprises a concert, movie, or another event with a limited attendance availability and the itinerary module 230 tracks availability for the itinerary item as responses are received from candidate trip participants. In some instances, candidate trip participants or member of a particular plan may be prompted to reimburse or share an expense associated with a particular itinerary item (e.g., splitting or allocating costs for a concert or movie prior to the itinerary module 230 acquiring tickets). For instance, the itinerary module 230 bills or facilitates payment (e.g., via electronic payment using payment credentials stored for respective users of the trip planning system 200) for an aspect of the itinerary item (e.g., an event ticket).

In still further embodiments, the itinerary module 230 accesses calendar data associated with candidate trip participants and assembles the trip itinerary, at least in part, according to the calendar data. For example, the itinerary module 230 assigns itinerary times according to time availability associated with respective plan members. That is to say, the itinerary module 230 identifies common available time among plan members and assigns an itinerary item to the identified common available time.

In still further example embodiments, the itinerary module 230 facilitates various ancillary or complementary activities associated with a particular itinerary item. For example, the complementary activities include for example, transportation, parking, scheduling, ticket purchasing. In a specific example, a particular itinerary item comprises a particular event (e.g., sports event, concert, etc.). In this specific example, the itinerary module 230 facilities purchase of the tickets for the particular event, determines transportation needs based on a number of participants and schedule of the event (e.g., public transportation or parking), recommends purchase of apparel for the event (e.g., sport logo hat for a sporting event), and so on.

In various embodiments, the itinerary module 230 facilitates the assembly of the trip itinerary from a guide or template itinerary. For example, the itinerary module 230 may generate a template itinerary or template trip plan from a previously designed or create trip plan or trip itinerary. In this example, the itinerary module 230 generates the template trip plan by using, and leaving out, a portion of the itinerary items and itinerary information included in the previously designed trip plan (e.g., using the same activities in a same order as the previously created plan).

At operation 440, the presentation module 210 causes presentation of the trip itinerary on a user interface of a user device of a candidate trip participant. For example, the organizing user may have invited other users to participate in the trip planning and the presentation module 210 causes presentation of the trip itinerary on a user interface of the invited users, candidate trip participants, or other users of the trip planning system 200. In some embodiments, the presentation module 210 causes presentation of the trip itinerary on a user interface of a user device of users that are not members of the social collaboration service. For instance, the trip itinerary may be publicly accessible or a direct invitation to view the trip itinerary is sent to a non-member allowing the non-member to view the trip itinerary.

At operation 450, the communication module 220 facilitates communication pertaining to the trip itinerary between the organizing user and the candidate trip participant. For example, the communication module 220 receives message that are comments regarding a particular content card included in the itinerary from the candidate trip participants and the organizing user. The communication module 220 also facilitates communications such as ratings, votes, requests to add, remove, or modify content cards or other itinerary items, requests to personalize content cards, comments, check-ins, geolocation shares, responses to polls, sharing media (e.g., photos), and so on.

FIG. 5 is a diagram 500 illustrating an example method for collaborative trip planning using a widget. In the diagram 500, a website 502, such as an advertiser's website or a third-party website, is shown including a button 504 (e.g., a “Plan This” button that when activated creates a content card and adds it to a particular itinerary). In an embodiment, the button 504 comprises a widget executing the on the website 502. In an example, a user of the website 502 activates the button 504 and a pop-up window 508 is presented as shown in website 506. The pop-up window can include a newly generated content card 510 for a content item of the third-party website. In a specific example, the user may be browsing third-party content presented on the third-party website and wish to “clip” a particular content item on the third-party website to create a content card for the particular content item to be added to a trip itinerary or viewed by the user at a later time. In this example, the user activates the button 504 and is directed to generate the content card 510 in the pop-up window 508 that provides various options to configure the content card or add it to a particular itinerary of the user.

In further example embodiment, the user may be directed to create a new plan at operation 512 or add the content card to an existing plan. In various embodiments, the user may subsequently edit plat details at operation 514, save the plant at operation 516, or add plan members at operation 528. For instance, if the user saves the newly create plan at operation 516, at operation 518, the user may be prompted to register, if not already a member, at the social collaboration service or the service hosting the trip planning system 200. At operation 520, the trip planning system 200 communications a confirmation to the user indicating successfully registration at the social collaboration service. Once registered, the user may directed to download an app 522, install a browser extension 524, or further edit the newly created plan details via a website 526.

In other example embodiments, the user may add plan members at operation 528. For example, the user can manually invite plan members at operation 536 (e.g., directly sending via email or SMS a particular invitee a link that, when activated, adds the invitee as a member to the plan). In another example, the user adds plan members via connected account invites at operation 530. For instance, the user may have one or more social networking services profiles that can be accessed by the trip planning system 200 (e.g., access friend or contacts lists stored by the social networking services). At operation 532, the organizing user view contacts from the connected social networking accounts and at operation 534, the user selects a particular contact among the available contacts. The selected contact is then sent an invitation at operation 538.

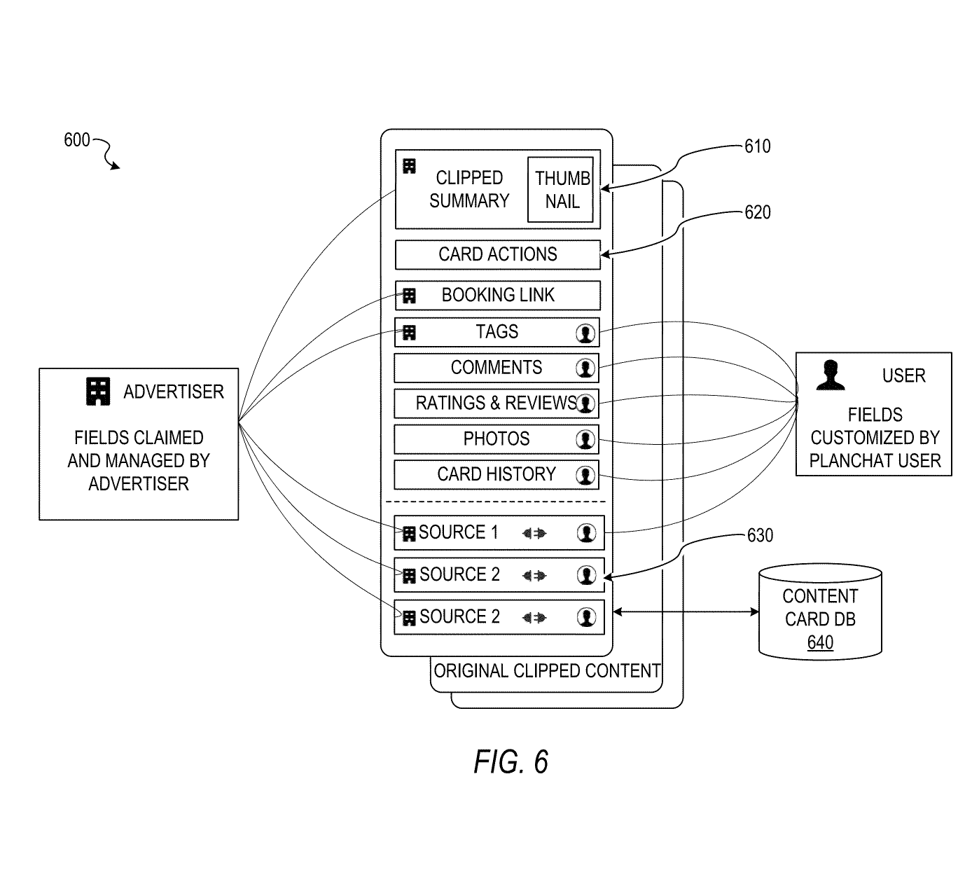

FIG. 6 is a diagram 600 showing various example components of an example content card. In an embodiment, element 610 comprises summarized content from a clipped source such as a summary description and a thumb nail image. The content card can also include content card actions 620 that include, for example, personalizing the content card or inserting the content card in to a particular trip itinerary. Element 630 shows that the data of the content card can be dynamically retrieved or accessed from sources such as content card database 640. For example, the data of the content card can be dynamic and updated periodically or each time the content card is loaded into memory. In a specific instance, if the content card includes pricing information for hotel rooms, the pricing information may be subject to change and are updated each time the content card is loaded.

In further example embodiments, the content card includes fields that can be modified by advertisers promoting products and services. For example, an advertiser may wish to advertise products or service that are complementary to the substance of the content card. In still further embodiments, the user can customize or personalize aspects of the content card such as adding comments, ratings, photos, and so on.

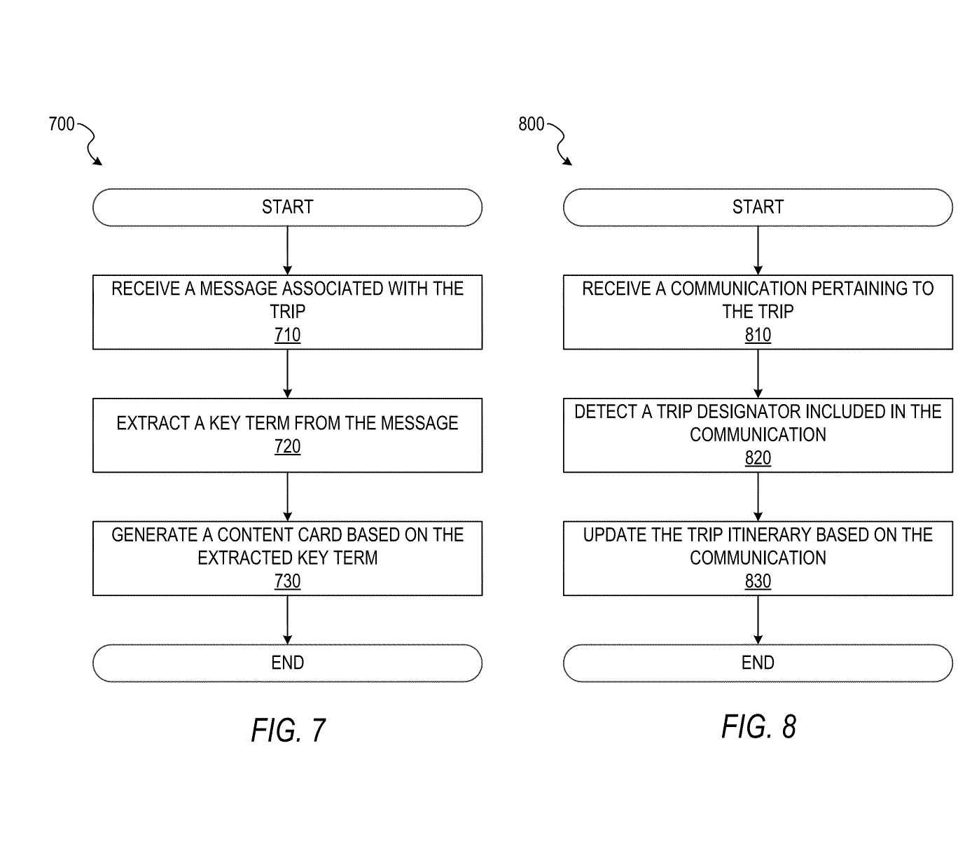

FIG. 7 is a flow diagram illustrating an example method for automatically generating content cards. The operations of method 700 are performed by components of the trip planning system 200 and can be performed in addition to or in conjunction with the operations of method 400 described above in connection with FIG. 4.

At operation 710, the communication module 220 receives a message associated with the trip from a user of the social collaboration service. For example, the communication module 220 may receive a message from candidate trip participants commenting about the trip. The messages may be received for example via email, text message, social media communications (e.g., a tweet or post), or another communications modality.

At operation 720, the content card module 240 extracts a key term from the message. For example, the text of the message is parsed by the content card module 240 and key terms from the text of the message are matched with key terms of existing content cards stored by the trip planning system 200. In a specific example, a particular message may include text indicating a particular activity such as skiing and the content card module 240 extracts skiing as a key term.

At operation 730, the content card module 240 generates or identifies a content card based on the extracted key term. In an embodiment, the content card module 240 identifies content cards by matching one or more key terms extracted from the message with one or more key terms corresponding to a particular content card. For example, if the content card module 240 extracts a ski resort name as a key term, then the content card module 240 identifies content cards associated with the particular ski resort by finding content cards with the ski resort name as a key term. The one or more identified content cards are then recommended to be added to a trip itinerary of the user.

In further example embodiments, the content card module 240 uses other information to identified or generate a content card based on the extracted key terms of the message. For instance, the content card module 240 may use information from a particular trip itinerary that the identified content card is to be suggested for insertion in. For instance, the content card module 240 identify content cards associated with a geolocation within a predetermined or dynamically determined distance of a geolocation associated with the particular trip itinerary (e.g., identifying ski rental equipment business near the trip destination).

FIG. 8 is a flow diagram illustrating an example method for detecting a trip designator in a communication and altering a trip itinerary. The operations of method 800 are performed by components of the trip planning system 200 and can be performed in addition to or in conjunction with the operations of method 400 described above in connection with FIG. 4.

At operation 810, the communication module 220 receives a communication pertaining to the trip. Similar to operation 710 described above, the messages may be received for example via email, text message, social media communications (e.g., a tweet or post), or another communications modality.

At operation 820, the itinerary module 230 detects a trip designator included in the communication. The trip designator corresponds to a particular trip itinerary and can be used by the itinerary module 230 to identify the particular trip. For example, the trip designator comprises a tag or another identifier that can be used the itinerary module 230 to identify a corresponding trip itinerary. In a specific example, the trip designator may be text such as “# SkiTrip” that corresponds to a particular trip itinerary of the user.

At operation 830, the itinerary module 230 updates the trip itinerary based on the communication. In an embodiment, the itinerary module 230 posts the communication to a feed associated with the trip itinerary so that the user can later view the communication in association with viewing the particular trip itinerary. In further embodiments, the itinerary module 230 parses the communication, identifies or infers an instruction from the communication and performs the instruction in association with the identified trip itinerary (e.g., adding a content card identified in the communication to the trip itinerary or inviting another user identified in the communication to participate in the trip planning)

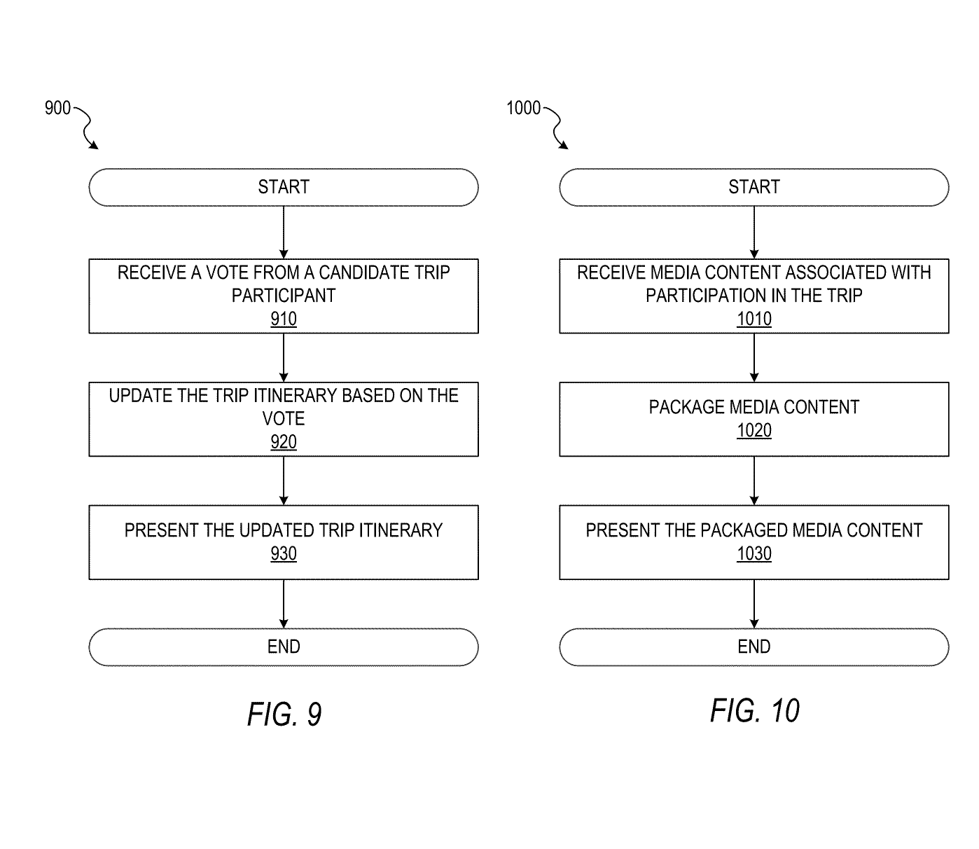

FIG. 9 is a flow diagram illustrating an example method for altering a trip itinerary based on votes from candidate trip participants. The operations of method 900 are performed by components of the trip planning system 200 and can be performed in addition to or in conjunction with the operations of method 400 described above in connection with FIG. 4.

At operation 910, the communication module 220 receives a vote from one or more candidate trip participant. For example, the candidate trip participant may vote on a particular content card included in the trip itinerary. The vote may indicate a like or dislike for the particular content card.

In other embodiments, the instigator or organizing user of the trip plan creates a poll that the communication module 220 broadcasts to member of the trip plan. A response to the poll can includes a wide variety of content such as content cards, images, text, or other content. The itinerary module 230 can generate items be voted on by members of the trip plan using the poll. For instance, a particular poll can include a variety of candidate activities or candidate content cards submitted by members of the trip plan and each candidate activities or candidate content cards may generate a vote. In this way, polling assists member of the trip plan collectively construct an itinerary or a portion of the itinerary.

At operation 920, the itinerary module 230 updates the trip itinerary based on the vote. For example, if a threshold number of votes are received (e.g., a majority or another user-specified quantity) the itinerary module 230 performs an action associated with the vote such as removing a particular content card from the trip itinerary or otherwise modifying the trip itinerary

At operation 930, the presentation module 210 presents the updates trip itinerary to the candidate trip participant. Similar to operation 440 described above, the presentation module 210 causes presentation of the trip itinerary on a user interface of the invited users, candidate trip participants, or other users of the trip planning system 200.

FIG. 10 is a flow diagram illustrating an example method for memorializing a trip using media content provided by trip participants. The operations of method 1000 are performed by components of the trip planning system 200 and can be performed in addition to or in conjunction with the operations of method 400 described above in connection with FIG. 4.

At operation 1010, the communication module 220 receives media content associated with participation in the trip. For example, participants of the trip may capture the experience with photos, videos, or other types of media. The participants can send captured media pertaining to the trip to the communication module 220 to be stored by the trip planning system 200 in association with the trip itinerary. The received media content can be shared among invitees of the trip itinerary or other members of the social collaboration service (e.g., the collective functionality provided by the trip planning system 200). In this way, a centralized repository for media associated with the trip is provided.

At operation 1020, the social module 250 packages the media content. That is to say, the social module 250 assembles the media content into a trip story memorializing the trip. For example, the social module 250 generates a montage of photos associated with the trip, an interactive map with media content positioned at a geolocation of where the media content was captured, or a user configured presentation package for the media content.

At operation 1030, the presentation module 210 causes presentation of the assembled trip story to members of the social collaboration service. For example, the social module 250 may make the trip story accessible to contact members of invitees or members of the trip itinerary. In some embodiments, the trip story is publicly accessible and is available in associated with a template version of the trip itinerary to assist future trip goes in planning a similar trip. In further embodiments, the trip story is shared, either publicly or privately, via integrations with social networking services and other third party software.

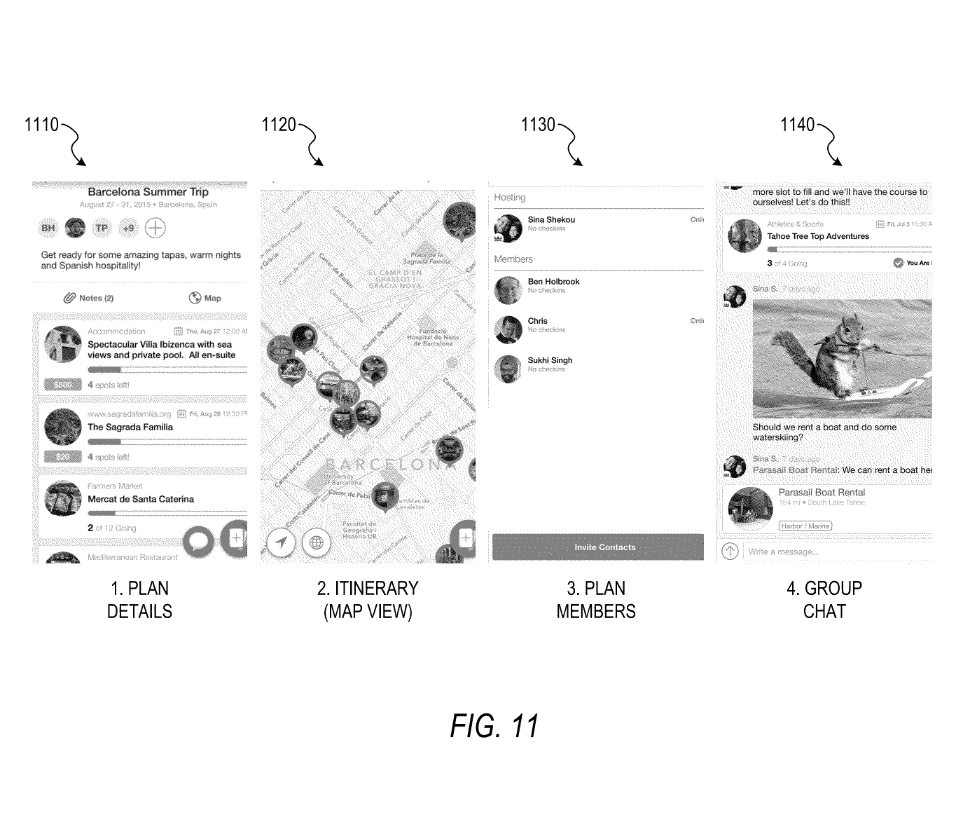

FIGS. 11-14 are user interface diagrams depicting various example user interfaces that may be presented by the presentation module 210 on a display screen of a mobile computing device (e.g., a smart phone), a web browser, or another client system. Although FIGS. 11-14 depict specific example user interfaces and user interface elements, these are merely non-limiting examples; many other alternate user interfaces and user interface elements can be generated by the presentation module 210 and cause to be presented to the user. It will be noted that alternate presentations of the displays of FIGS. 11-14 can include additional information, graphics, options, and so forth. Alternatively, other presentations can include less information, or provide abridged information for easy use by the user.

FIG. 11 depicts example user interfaces 1110, 1120, 1130, and 1140. The user interface 1110 shows example plan details for a particular trip plan or trip itinerary. A user of the trip planning system 200 can edit, alter, or otherwise modify the trip itinerary using a user interface such as the user interface 1110. The user interface 1120 shows an example itinerary map that includes geolocation information associated with content card included in the trip itinerary. In the user interface 1120, the geolocation information may be rendered as a layer superimposed on a map of a region associated with the trip itinerary. The user interface 1130 shows example members of a social networking service that may be invited to participate in collaboratively planning a trip. The user interface 1140 shows an example group chat that can include messages that pertain to a particular trip itinerary or a particular content card.

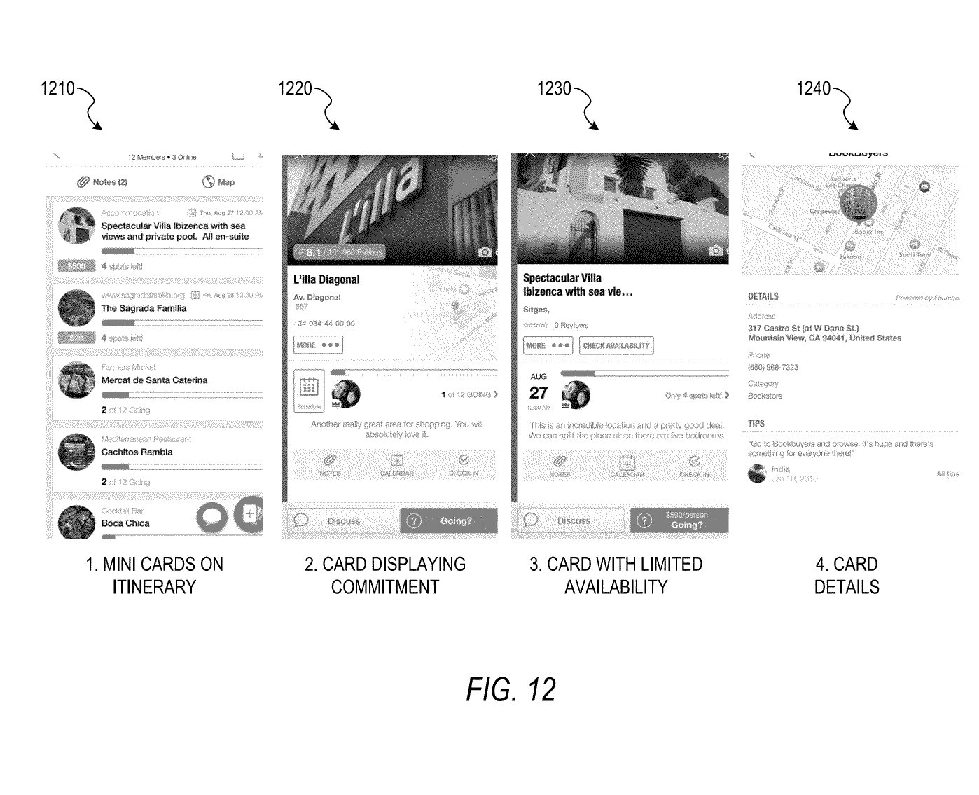

FIG. 12 depicts example user interfaces 1210, 1220, 1230, and 1240. The user interface 1210 shows a “mini cards” included in a trip itinerary. These “mini cards” may be abridged versions of content cards show sequentially according to a time associated with respective content cards. The user interface 1220 shows an example content card with a commitment from a candidate trip participant. The user interface 1230 shows an example content card with limited availability such as restaurant or hotel with limited availability for a certain period of time. The user interface 1240 shows example content card details for a particular content card. For instance, the content card details may be an unabridged version of a particular content card.

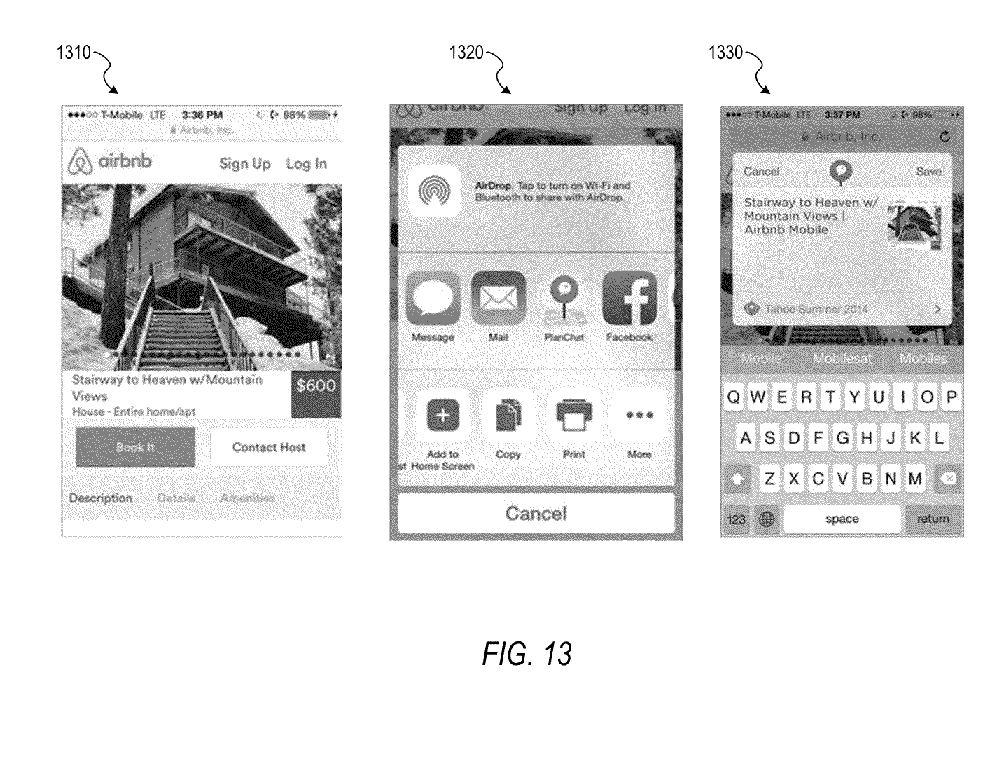

FIG. 13 depicts example user interfaces 1310, 1320, and 1330. The user interface 1310 shows an example browser or mobile app that includes third-party content with an embedded widget that renders a button. The user interface 1320 shows an example use of native mobile operating system functionality to facilitate clipping content while browsing on a mobile computing device. In other embodiments, the trip planning system 200 facilitates clipping via integration of a widget accessible while browsing third-party content. As show in the user interface 1330, activation of the widget may generate a communication or send an instruction to the trip planning system 200 to generate a content card or add a content card to a particular trip itinerary.

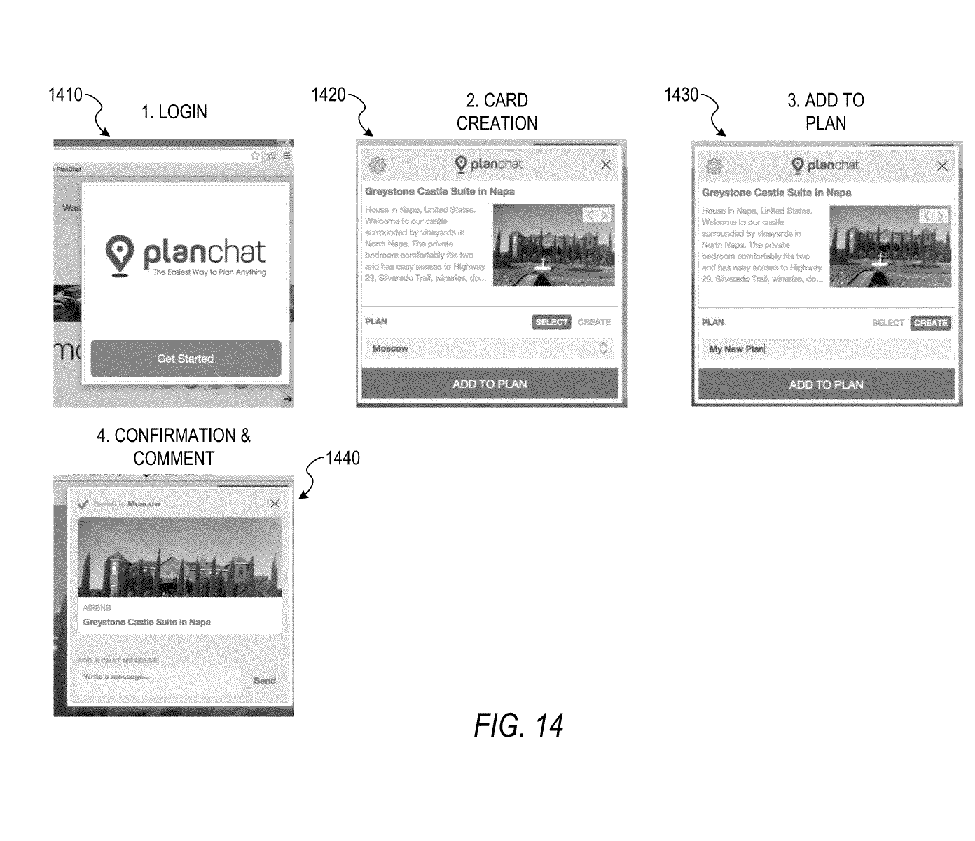

FIG. 14 depicts example user interfaces 1410, 1420, 1430, and 1440. The user interface 1410 depicts an example login screen for the trip planning system 200. The user interface 1420 shows an example interface for creation a content card. The user interface 1430 shows an example interface for adding items to the trip itinerary. The user interface 1440 shows an example interface for commenting on a particular content card or itinerary item.

Certain embodiments are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules can be located in a single geographic location (e.g., within a home environment, an office environment, or a server farm). In other example embodiments, the processors or processor-implemented modules are distributed across a number of geographic locations.

The modules, methods, applications and so forth described in conjunction with FIGS. 1-14 are implemented in some embodiments in the context of a machine and an associated software architecture. The sections below describe representative software architecture and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, and the like. While yet another combination produces a server computer for use within a cloud computing architecture. Not all combinations of such software and hardware architectures are presented here as those of skill in the art can readily understand how to implement the inventive subject matter in different contexts from the disclosure contained herein.

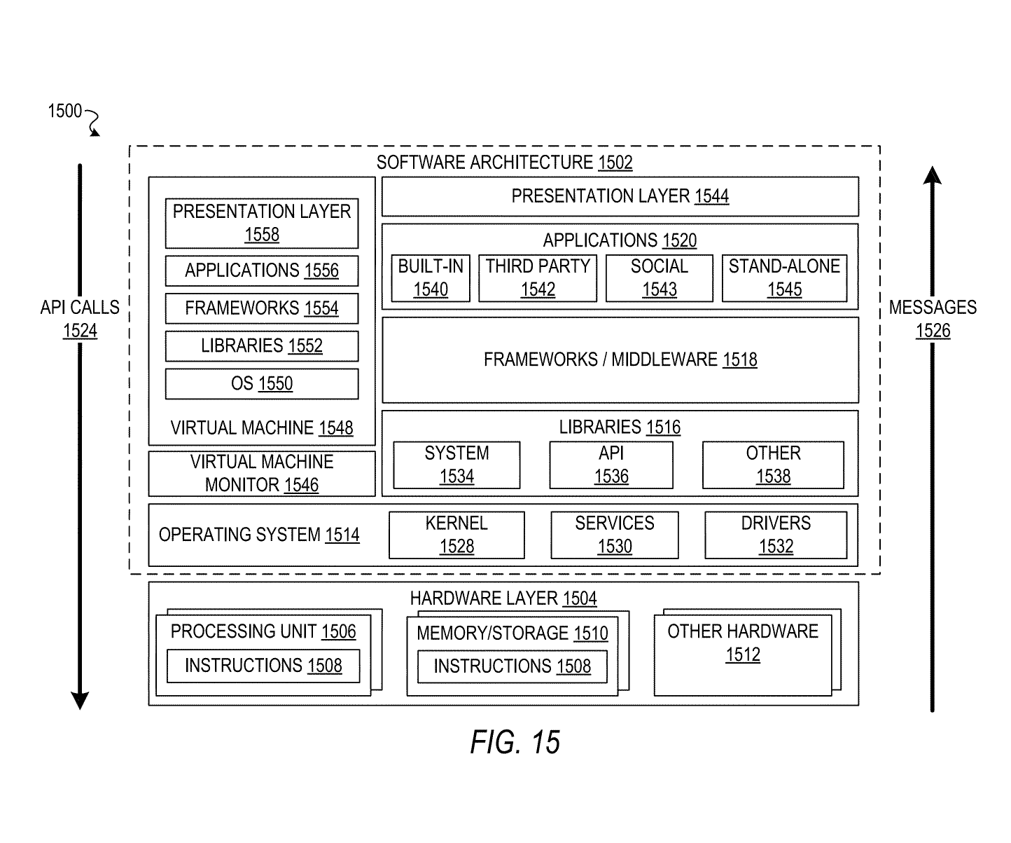

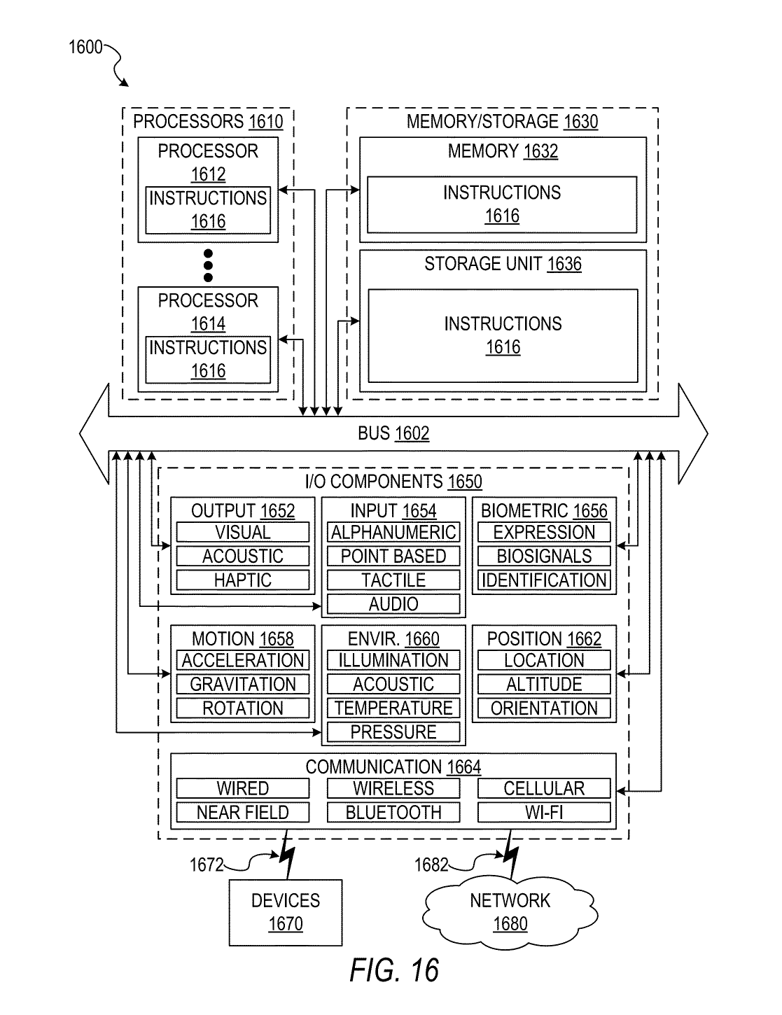

FIG. 15 is a block diagram 1500 illustrating a representative software architecture 1502, which may be used in conjunction with various hardware architectures herein described. FIG. 15 is merely a non-limiting example of a software architecture and it will be appreciated that many other architectures may be implemented to facilitate the functionality described herein. The software architecture 1502 may be executing on hardware such as machine 1600 of FIG. 16 that includes, among other things, processors 1610, memory/storage 1630, and I/O components 1650. A representative hardware layer 1504 is illustrated and can represent, for example, the machine 1600 of FIG. 16. The representative hardware layer 1504 comprises one or more processing units 1506 having associated executable instructions 1508. Executable instructions 1508 represent the executable instructions of the software architecture 1502, including implementation of the methods, modules and so forth of FIGS. 1-14. Hardware layer 1504 also includes memory and storage modules 1510, which also have executable instructions 1508. Hardware layer 1504 may also comprise other hardware 1512, which represents any other hardware of the hardware layer 1504, such as the other hardware illustrated as part of machine 1600.

In the example architecture of FIG. 15, the software architecture 1502 may be conceptualized as a stack of layers where each layer provides particular functionality. For example, the software architecture 1502 may include layers such as an operating system 1514, libraries 1516, frameworks/middleware 1518, applications 1520 and presentation layer 1544. Operationally, the applications 1520 or other components within the layers may invoke application programming interface (API) calls 1524 through the software stack and receive a response, returned values, and so forth illustrated as messages 1526 in response to the API calls 1524. The layers illustrated are representative in nature and not all software architectures have all layers. For example, some mobile or special purpose operating systems may not provide the frameworks/middleware 1518, while others may provide such a layer. Other software architectures may include additional or different layers.

The operating system 1514 may manage hardware resources and provide common services. The operating system 1514 may include, for example, a kernel 1528, services 1530, and drivers 1532. The kernel 1528 may act as an abstraction layer between the hardware and the other software layers. For example, the kernel 1528 may be responsible for memory management, processor management (e.g., scheduling), component management, networking, security settings, and so on. The services 1530 may provide other common services for the other software layers. The drivers 1532 may be responsible for controlling or interfacing with the underlying hardware. For instance, the drivers 1532 may include display drivers, camera drivers, BLUETOOTH® drivers, flash memory drivers, serial communication drivers (e.g., Universal Serial Bus (USB) drivers), WI-FI® drivers, audio drivers, power management drivers, and so forth depending on the hardware configuration.

The libraries 1516 may provide a common infrastructure that may be utilized by the applications 1520 or other components or layers. The libraries 1516 typically provide functionality that allows other software modules to perform tasks in an easier fashion than to interface directly with the underlying operating system 1514 functionality (e.g., kernel 1528, services 1530 or drivers 1532). The libraries 1516 may include system libraries 1534 (e.g., C standard library) that may provide functions such as memory allocation functions, string manipulation functions, mathematic functions, and the like. In addition, the libraries 1516 may include API libraries 1536 such as media libraries (e.g., libraries to support presentation and manipulation of various media format such as MPREG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1516 may also include a wide variety of other libraries 1538 to provide many other APIs to the applications 1520 and other software components/modules.

The frameworks/middleware 1518 (also sometimes referred to as middleware) may provide a higher-level common infrastructure that may be utilized by the applications 1520 or other software components/modules. For example, the frameworks/middleware 1518 may provide various graphic user interface (GUI) functions, high-level resource management, high-level location services, and so forth. The frameworks/middleware 1518 may provide a broad spectrum of other APIs that may be utilized by the applications 1520 or other software components/modules, some of which may be specific to a particular operating system or platform.

The applications 1520 include built-in applications 1540 or third party applications 1542. Examples of representative built-in applications 1540 may include, but are not limited to, a contacts application, a browser application, a book reader application, a location application, a media application, a messaging application, or a game application. Third party applications 1542 may include any of the built-in applications as well as a broad assortment of other applications. In a specific example, the third party application 1542 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or other mobile operating systems. In this example, the third party application 1542 may invoke the API calls 1524 provided by the mobile operating system such as operating system 1514 to facilitate functionality described herein. In an example embodiment, the applications 1520 include a social application 1543 that includes the trip planning system 200 as part of the application. In another example embodiment, the applications 1520 include a stand-alone application 1545 that includes the trip planning system 200.

The applications 1520 may utilize built-in operating system functions (e.g., kernel 1528, services 1530 or drivers 1532), libraries (e.g., system libraries 1534, API libraries 1536, and other libraries 1538), frameworks/middleware 1518 to create user interfaces to interact with users of the system. Alternatively, or additionally, in some systems interactions with a user may occur through a presentation layer, such as presentation layer 1544. In these systems, the application/module “logic” can be separated from the aspects of the application/module that interact with a user.

Some software architectures utilize virtual machines. In the example of FIG. 15, this is illustrated by virtual machine 1548. A virtual machine creates a software environment where applications/modules can execute as if they were executing on a hardware machine (such as the machine 1600 of FIG. 16, for example). The virtual machine 1548 is hosted by a host operating system (operating system 1514 in FIG. 16) and typically, although not always, has a virtual machine monitor 1546, which manages the operation of the virtual machine 1548 as well as the interface with the host operating system (i.e., operating system 1514). A software architecture executes within the virtual machine 1548 such as an operating system 1550, libraries 1552, frameworks/middleware 1554, applications 1556 or presentation layer 1558. These layers of software architecture executing within the virtual machine 1548 can be the same as corresponding layers previously described or may be different.

FIG. 16 is a block diagram illustrating components of a machine 1600, according to some example embodiments, able to read instructions from a machine-readable medium (e.g., a machine-readable storage medium) and perform any one or more of the methodologies discussed herein. Specifically, FIG. 16 shows a diagrammatic representation of the machine 1600 in the example form of a computer system, within which instructions 1616 (e.g., software, a program, an application, an applet, an app, or other executable code) for causing the machine 1600 to perform any one or more of the methodologies discussed herein can be executed. For example, the instructions 1616 can cause the machine 1600 to execute the flow diagrams of FIGS. 3-5 and 7-10. Additionally, or alternatively, the instruction 1616 can implement the presentation module 210, the communication module 220, the itinerary module 230, the content card module 240, the social module 250, and so forth. The instructions 1616 transform the general, non-programmed machine into a particular machine programmed to carry out the described and illustrated functions in the manner described. In alternative embodiments, the machine 1600 operates as a standalone device or can be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1616, sequentially or otherwise, that specify actions to be taken by the machine 1600. Further, while only a single machine 1600 is illustrated, the term “machine” shall also be taken to include a collection of machines 1600 that individually or jointly execute the instructions 1616 to perform any one or more of the methodologies discussed herein.

The machine 1600 can include processors 1610, memory/storage 1630, and I/O components 1650, which can be configured to communicate with each other such as via a bus 1602. In an example embodiment, the processors 1610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 1612 and processor 1614 that may execute instructions 1616. The term “processor” is intended to include multi-core processor that may comprise two or more independent processors (sometimes referred to as “cores”) that can execute instructions contemporaneously. Although FIG. 16 shows multiple processors 1610, the machine 1600 may include a single processor with a single core, a single processor with multiple cores (e.g., a multi-core processor), multiple processors with a single core, multiple processors with multiples cores, or any combination thereof.

The memory/storage 1630 can include a memory 1632, such as a main memory, or other memory storage, and a storage unit 1636, both accessible to the processors 1610 such as via the bus 1602. The storage unit 1636 and memory 1632 store the instructions 1616 embodying any one or more of the methodologies or functions described herein. The instructions 1616 can also reside, completely or partially, within the memory 1632, within the storage unit 1636, within at least one of the processors 1610 (e.g., within the processor's cache memory), or any suitable combination thereof, during execution thereof by the machine 1600. Accordingly, the memory 1632, the storage unit 1636, and the memory of the processors 1610 are examples of machine-readable media.

As used herein, the term “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1616. The term “machine-readable medium” shall also be taken to include any medium, or combination of multiple media, that is capable of storing instructions (e.g., instructions 1616) for execution by a machine (e.g., machine 1600), such that the instructions, when executed by one or more processors of the machine 1600 (e.g., processors 1610), cause the machine 1600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1650 can include a wide variety of components to receive input, provide output, produce output, transmit information, exchange information, capture measurements, and so on. The specific I/O components 1650 that are included in a particular machine will depend on the type of machine. For example, portable machines such as mobile phones will likely include a touch input device or other such input mechanisms, while a headless server machine will likely not include such a touch input device. It will be appreciated that the I/O components 1650 can include many other components that are not shown in FIG. 16. The I/O components 1650 are grouped according to functionality merely for simplifying the following discussion, and the grouping is in no way limiting. In various example embodiments, the I/O components 1650 can include output components 1652 and input components 1654. The output components 1652 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1654 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 1650 can include biometric components 1656, motion components 1658, environmental components 1660, or position components 1662 among a wide array of other components. For example, the biometric components 1656 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1658 can include acceleration sensor components (e.g., an accelerometer), gravitation sensor components, rotation sensor components (e.g., a gyroscope), and so forth. The environmental components 1660 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1662 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1650 may include communication components 1664 operable to couple the machine 1600 to a network 1680 or devices 1670 via a coupling 1682 and a coupling 1672, respectively. For example, the communication components 1664 include a network interface component or other suitable device to interface with the network 1680. In further examples, communication components 1664 include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 1670 may be another machine or any of a wide variety of peripheral devices (e.g., a peripheral device coupled via a Universal Serial Bus (USB)).

Moreover, the communication components 1664 can detect identifiers or include components operable to detect identifiers. For example, the communication components 1664 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1664, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1680 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 1680 or a portion of the network 1680 may include a wireless or cellular network, and the coupling 1682 may be a Code Division Multiple Access (CDMA) connection, a Global System for Mobile communications (GSM) connection, or other type of cellular or wireless coupling. In this example, the coupling 1682 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1616 can be transmitted or received over the network 1680 using a transmission medium via a network interface device (e.g., a network interface component included in the communication components 1664) and utilizing any one of a number of well-known transfer protocols (e.g., Hypertext Transfer Protocol (HTTP)). Similarly, the instructions 1616 can be transmitted or received using a transmission medium via the coupling 1672 (e.g., a peer-to-peer coupling) to devices 1670. The term “transmission medium” shall be taken to include any intangible medium that is capable of storing, encoding, or carrying the instructions 1616 for execution by the machine 1600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving an indication of a content item associated with a trip from a particular user of a social collaboration service;
generating, using at least one hardware processor of a machine, a content card representing the content item;
assembling a trip itinerary including the content card for an organizing user of the social collaboration service;
causing presentation of the trip itinerary on a user interface of a user device of a candidate trip participant; and
facilitating communication pertaining to the trip itinerary between the organizing user and the candidate trip participant.

2. The method of claim 1, further comprising:
receiving the indication of the content item associated with the trip from a widget embedded in a third party content, wherein the widget comprises a button presented with the third party content.

3. The method of claim 1, further comprising:
receiving a message associated with the trip from a user of the social collaboration service;
extracting a key term from the message; and
generating a new content card based on the extracted key term.

4. The method of claim 1, further comprising:
receiving a communication pertaining to the trip;
detecting a trip designator, included in the communication, corresponding to the trip itinerary; and
in response to detecting the trip designator, updating the trip itinerary based on the communication.

5. The method of claim 1, wherein the candidate trip participant is not a member of the social collaboration service.

6. The method of claim 1, further comprising:
receiving a vote corresponding to the content card included in the trip itinerary;
updating the trip itinerary based on the vote; and
causing presentation of the updated trip itinerary on a user interface of a user device of the organizing user.

7. The method of claim 1, further comprising:
receiving media content associated with participation in the trip;
assembling the media content into a trip story memorializing the trip; and
causing presentation of the assembled trip story to members of the social collaboration service.

8. A system comprising:
a communication module to receive an indication of a content item associated with a trip from a particular user of a social collaboration service;
a content card module to generate, implemented by at least one hardware processor of a machine, a content card representing the content item;
an itinerary module to assemble a trip itinerary including the content card for an organizing user of the social collaboration service;
a presentation module to cause presentation of the trip itinerary on a user interface of a user device of a candidate trip participant; and
the communication module further to facilitate communication pertaining to the trip itinerary between the organizing user and the candidate trip participant.

9. The system of claim 8, wherein the communication module is further to receive the indication of the content item associated with the trip from a widget embedded in a third party content, wherein the widget comprises a button presented with the third party content.

10. The system of claim 8, wherein:
the communication module further to receive a message associated with the trip from a user of the social collaboration service;
the content card module further to:
extract a key term from the message; and
generating a new content card based on the extracted key term.

11. The system of claim 8, wherein:
the communication module further to receive a communication pertaining to the trip;
the itinerary module further to:
detect a trip designator, included in the communication, corresponding to the trip itinerary; and
in response to detecting the trip designator, update the trip itinerary based on the communication.

12. The system of claim 8, wherein the candidate trip participant is not a member of the social collaboration service.

13. The system of claim 8, wherein:
the communication module to receive a vote corresponding to the content card included in the trip itinerary;
the itinerary module to update the trip itinerary based on the vote; and
the presentation module to cause presentation of the updated trip itinerary on a user interface of a user device of the organizing user.

14. A machine-readable medium having no transitory signals and storing instructions that, when executed by at least one processor of a machine, cause the machine to perform operations comprising:
receiving an indication of a content item associated with a trip from a particular user of a social collaboration service;
generating, using at least one hardware processor of a machine, a content card representing the content item;
assembling a trip itinerary including the content card for an organizing user of the social collaboration service;
causing presentation of the trip itinerary on a user interface of a user device of a candidate trip participant; and
facilitating communication pertaining to the trip itinerary between the organizing user and the candidate trip participant.

15. The machine-readable medium of claim 14, further comprising:
receiving the indication of the content item associated with the trip from a widget embedded in a third party content, wherein the widget comprises a button presented with the third party content.

16. The machine-readable medium of claim 14, further comprising:
receiving a message associated with the trip from a user of the social collaboration service;
extracting a key term from the message; and
generating a new content card based on the extracted key term.

17. The machine-readable medium of claim 14, further comprising:
receiving a communication pertaining to the trip;
detecting a trip designator, included in the communication, corresponding to the trip itinerary; and
in response to detecting the trip designator, updating the trip itinerary based on the communication.

18. The machine-readable medium of claim 14, wherein the candidate trip participant is not a member of the social collaboration service.

19. The machine-readable medium of claim 14, further comprising:
receiving a vote corresponding to the content card included in the trip itinerary;
updating the trip itinerary based on the vote; and
causing presentation of the updated trip itinerary on a user interface of a user device of the organizing user.

20. The machine-readable medium of claim 14, further comprising:
receiving media content associated with participation in the trip;
assembling the media content into a trip story memorializing the trip; and
causing presentation of the assembled trip story to members of the social collaboration service.
